(19) United States
(12) Patent Application Publication
(10) Pub. No.: US 2008/0066167 A1
(43) Pub. Date: Mar. 13, 2008

(54) PASSWORD BASED ACCESS INCLUDING ERROR ALLOWANCE

(76) Inventor: MICHAEL J. ANDRI, Portland, OR (US)

Correspondence Address: Michael J. Andri, Apt 504, 416 NW 13th Ave, Portland, OR, 97209, US

(21) Appl. No.: 11/852,921

(22) Filed: Sep. 10, 2007

Related U.S. Application Data
(60) Provisional application No. 60/843,883, filed on Sep. 12, 2006.

(51) Int. Cl. H04L 9/32

(52) U.S. Cl. 726/5

(57) ABSTRACT

An approach is provided for enabling a client user to access secure information or services via a security code including a password and/or username even when the security code provided by the client user includes one or more errors. As one example, a level of error allowance may be selected by a system administrator based on a prescribed minimum level of security and the security code selected by the client user. The application of error allowance can reduce the number of times a client user is denied access to requested information or services due to incorrect or mistyped security code input while also ensuring the prescribed minimum level of security is retained.

### CROSS-REFERENCE TO RELATED APPLICATIONS

This application claims priority to U.S. Provisional Application No. 60/843,883, filed on Sep. 12, 2006, by Michael Andri, and titled PASSWORD BASED ACCESS INCLUDING ERROR ALLOWANCE. The contents of the above are incorporated in their entirety for all purposes.

### BACKGROUND AND SUMMARY

The use of security code based access to secure information via passwords and/or usernames has increased dramatically with the increase use of data networks in our daily lives such as the Internet, automated teller machines (ATM)s, or voicemail, for example. The desire for on-demand access to protected information and services coupled with increases in the level of security provided by these networks has resulted in a greater use of security code based validation of the user's identity.

The inventor of the present disclosure has recognized that the increased use of security code based access has also served to complicate the user experience by reducing the ease in which a user may gain access to their requested information and services. As one example, a password may be incorrectly provided by a user in an attempt to gain access due to a variety of reasons, including user error, user confusion, and/or user disability, thereby delaying access to the requested information or services, and further causing frustration with the client device or operating system.

The cause of security code input error may vary depending on the individual and/or environment. Some of these errors may be the result of a keystroke error due to a misplaced finger, user confusion, or failure to recall their personal security code. Further, some errors may result from the reduction in keypad size for many mobile devices such as mobile phones, PDAs, and notebook computers. These issues may be exacerbated when the person entering the security code is physically afflicted with reduced vision, tremors, lost or malformed appendages, or other disability. Further still, factors such as the physical size of a person's finger or hand may correspond to the frequency or type of input errors that may occur. Each of the above issues may be further magnified as the technology using population continues to age and the user of security code protection of data networks increases.

Some operating systems may provide some level of corrective action in response to incorrect keystrokes or misspelled words. For example, some word processing software programs can automatically correct certain types of user input errors based on language references stored in memory. However, these approaches have not addressed the issues relating to applications where security code based access is used. In other words, there appears to be a lack of teaching of how the level of security for code based systems may be maintained while also improving the user experience.

In one approach, as described herein, some of the above issues may be addressed by an operating system that applies at least some level of error allowance to a user input based on a prescribed level of security, the characteristics of the security code, and learned behavior of the user with respect to the their system hardware, for example. As a non-limiting example, an error allowance may be applied by the operating system that permits the user to successfully gain access to the security code protected information or service even when their security code input includes an error.

Additionally, the inventor of the present disclosure has also recognized that the level of security may be potentially reduced if the user is permitted to gain access even when they have provided an erroneous security code input. Thus, in some examples, it the number of acceptable errors or security code variants may be reduced by identifying the errors that are more probable for the user to make such as by learning errors that are common to the particular user and/or the particular hardware utilized by the user.

For example, one or more incorrect key strokes or characters of a password string may be accepted when the physical location of the incorrect key is adjacent to or within a threshold proximity of the correct key on the key pad. With regards to a QWERTY style keyboard for the English language, if the correct or expected character of a password was a “G” key, then one or more characters adjacent the “G” key may instead be acceptable by the operating system, such as the “F”, “V”, “B”, “H”, “Y”, or “T” keys, for example. In yet another example, errors that include an inversion in the sequential order of two or more characters of a password string may be acceptable to the operating system, thereby enabling the user to gain access as requested. Still other key stroke errors such as omissions, multi-strokes, or incorrect case may be accepted as will be described herein in greater detail.

While the above approaches recognized by the inventor may reduce delays in some password based access scenarios, security may be still be decreased in some cases below a prescribed threshold level of security. For example, depending on the length of the selected password string and the range of characters accepted by the operating system, the level of security may be reduced by a factor of 10 or more where error allowance is used, since variants of the password may be used to gain access.

Thus, in yet another approach, also set forth by the present disclosure, the above issues may be addressed by varying a level error allowance provided to a user based on a condition of the security code, such as the string length or quantity of accepted characters. For example, a first password having a first string length may result in a lower error allowance than a second password having a second string length that is greater than the first string length. In this manner, a desired level of security may be maintained while also allowing one or more password and/or username variants to be accepted.

In each of the above examples, the level of error allowance as well as security code criteria can be selected by the user of the client device and/or an administrator. For example, where the client device is configured to communicate with other elements of a network, a network administrator can be provided with an opportunity to select minimum security code parameters and a level of error allowance that may be applied to a request by the client user for security code protected information or services.

### DESCRIPTION OF THE DRAWINGS

FIG. 1A shows a schematic depiction of an example client network.

FIG. 1B shows a schematic depiction of an example client device.

FIG. 2 shows a schematic depiction of the principle data flows within an operating system.

FIGS. 3A and 3B are flow charts depicting example control routines.

FIG. 4 shows an example graphical user interface that may be displayed by a client device.

FIGS. 4 and 6 shows a schematic depiction of an example input device of a client device.

FIG. 7 shows various example password and/or username strings.

FIG. 8 shows various example errors that may occur in password or username strings.

FIGS. 9 and 10 show example routines that may be performed by the operating system.

FIG. 11 shows various string variants for a password and/or username.

FIGS. 12-17 illustrate example levels of error allowance with reference to the input devices of FIGS. 4 and 6.

FIG. 18 illustrates another example of a graphical user interface that may be displayed via the client device.

FIG. 19 is an example graphical user interface for an administrator.

FIG. 20 provides a working example of how a minimum level of security, password parameters, and error allowance are related.

### DETAILED DESCRIPTION

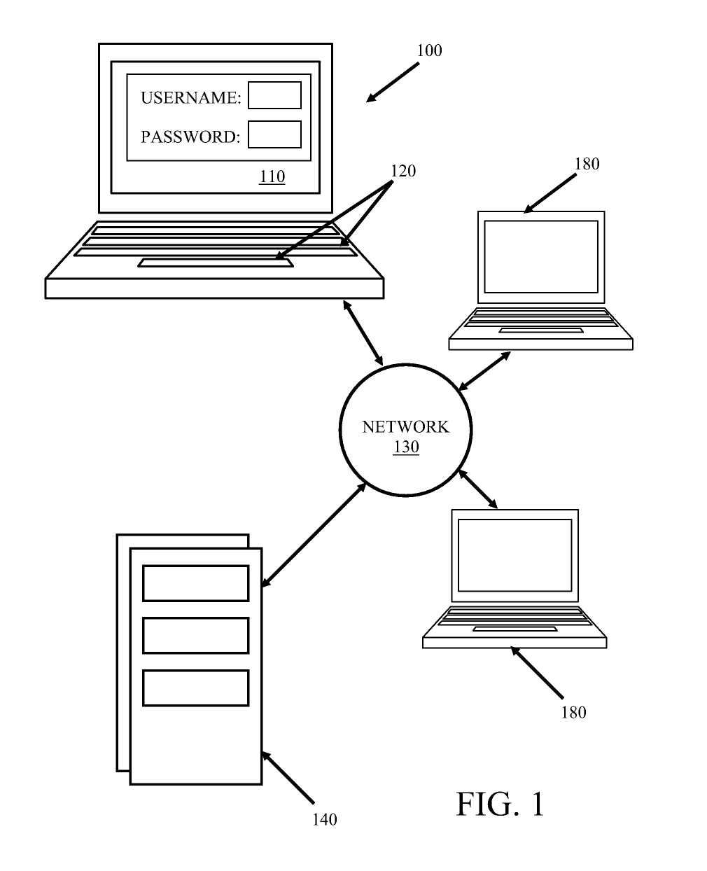

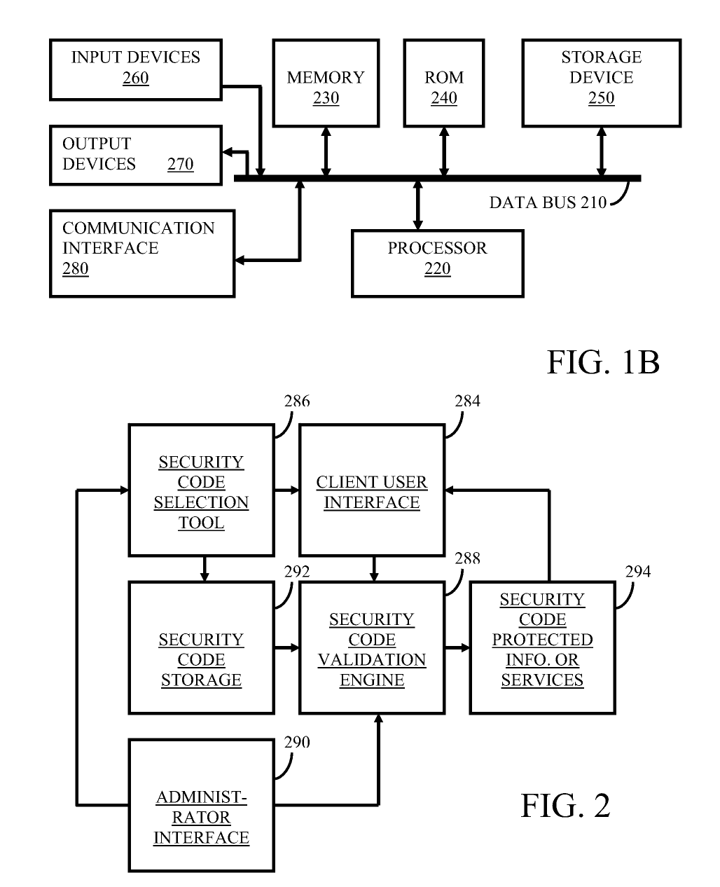

FIG. 1A illustrates an example operating system by which the various approaches that are described herein may be implemented. The operating system can be configured to enabling a user of a client device to gain access to information or services that are protected via security code. As described herein, the term security code can refer to one or more of a password and a username, among other security code implementations. The operating system for carrying out this operation may include at least a client device as indicated at 100 in FIG. 1A. In some examples, the operating system may include a network of one or more client devices and/or servers such as server 140 communicating via a network indicated at 130. Network 130 may include a local area network (LAN), a wide area network (WAN) (e.g. the Internet), a telephone network, such as the Public Switched Telephone Network (PSTN), a digital cable television network, an intranet, or other suitable network, or a combination thereof. However, it should be appreciated that the approaches described herein are not necessarily limited to a network application, but may be performed on a stand alone client device, in some examples.

In the example of FIG. 1A, three client devices and one server have been illustrated as communicating with network 130. In practice, there may be more or less client devices and/or servers communicating via the network. Also, in some instances, a client device may perform at least a portion of the functions of a server and a server may perform at least a portion of the functions of a client device. Further, in some examples, a client device may not necessarily communicate with an external device via a network, but may instead receive, validate and grant access to information or control functions locally at the client device based on a user input such as a password and/or username.

Client device 100 may include a mainframe, minicomputer, personal computer laptop computer, notebook computer, personal digital assistant, cell phone, mobile phone, television, remote control, global positioning system (GPS) device, automated teller machine (ATM), business transaction device, credit card reader, vehicle console, or other suitable device for enabling a user to connect to network 130. The client device 100 may transmit data over network 130 or receive data from network 130 via a wired, wireless, or optical connection.

Client Device 100 may include an input device such as a keyboard or keypad 120 and an output device such as a display 110. FIG. 1B illustrates example client device 100 in greater detail consistent with the present disclosure. The client device 100 may include one or more of a data bus 210, a processor 220, a main memory 230, a read only memory (ROM) 240, a storage device 250, an input device 260 (e.g. keyboard 120), an output device 270 (e.g. display 110), and a communication interface 280 among other devices and/or components suitable for carrying out one or more of the approaches described herein.

Data bus 210 may include one or more buses that permit communication among the components of the client device 100. The processor 220 may include any suitable type of processor or microprocessor that interprets and executes instructions. Memory 230 may include random access memory (RAM) or another type of dynamic storage device that stores information and instructions for execution by the processor 220. The ROM 240 may include a ROM device or another type of static storage device that stores static information and instructions for use by the processor 220. The storage device 250 may include a magnetic, optical, flash, and/or other suitable recording medium and its corresponding drive. As will be described in greater detail below, information such as a user input or values based on a user input may be stored by the operating system. As described herein, the act of storing the user input or value may be achieved by storing at least a portion of the user input or other value locally at the client device in either memory and/or the storage device, and/or other devices communicating with the client device such as server 140 may store at least a portion of the user input or other value. In this manner, the operating system may store user inputs or information derived from the user inputs, among other suitable information.

Input device 260 may include one or more devices that enable a user to input information to the client device 100, such as a keyboard, keypad, a mouse, a button, a switch, a controller, a pen, voice recognition and/or biometric mechanisms, etc. Output device 270 may include one or more devices that output information to the user, including a display, a printer, a speaker, etc. In some cases, a common device may perform the function of input and output device such as via a touch screen display or a keyboard displayed by the display device that may be selected via a mouse or controller. Communication interface 280 may include any suitable device that enables client device 100 to communicate with other devices and/or portion of the operating system. For example, the communication interface 280 may include one or more devices for communicating with another device or system via a network, such as network 130.

As will be described in detail below, client device 100, may be operated by a client user to access information stored locally on the client device and/or remotely on another client device (e.g. client 180) or server (e.g. server 140) in communication with client device 100 via network 130. The client device 100 may perform these operations in response to processor 220 executing software instructions contained in a computer-readable medium, such as memory 230. A computer-readable medium may be defined as one or more memory devices and/or carrier waves. The software instructions or computer readable code may be read into memory 230 from another computer-readable medium, such as the data storage device 250, or from another device external the client device via the communication interface 280. As one example, a portion of the computer-readable code may be stored in the client device and a portion of the computer-readable code may be stored in a device communicatively coupled with the client device. The software instructions contained in memory 230 or in memory of a device external the client device and communicatively coupled thereto may cause processor 220 to perform activities that enables a user to send and/or receive information via the client device. Alternatively, hardwired circuitry may be used in place of or in combination with software instructions to implement processes or methods consistent with the present disclosure. Thus, the present disclosure is not necessarily limited to any specific combination of hardware circuitry and software.

The server 140 may include one or more types of computer systems, such as a mainframe, minicomputer, or personal computer, capable of connecting to the network 130 to enable server 140 to communicate with the client device 100. In alternative implementations, server 140 may include one or more devices for directly communicating with one or more client devices. Server 140 can transmit data over network 130 and/or receive data from the network 130 via a wired, wireless, or optical connection.

The server may be configured in a manner similar to that described above in reference to FIG. 1B for client device 100. As one example, server 140 may include a computer-readable medium including code for carrying out some or all of the various functions and approaches described herein. Further, server 140 may store information such as documents, web pages, passwords and/or usernames or variants thereof, or other suitable information in a format that is accessible by the client device 100. Further, in some examples, information stored by the operating system in either the client device or the server may be encrypted.

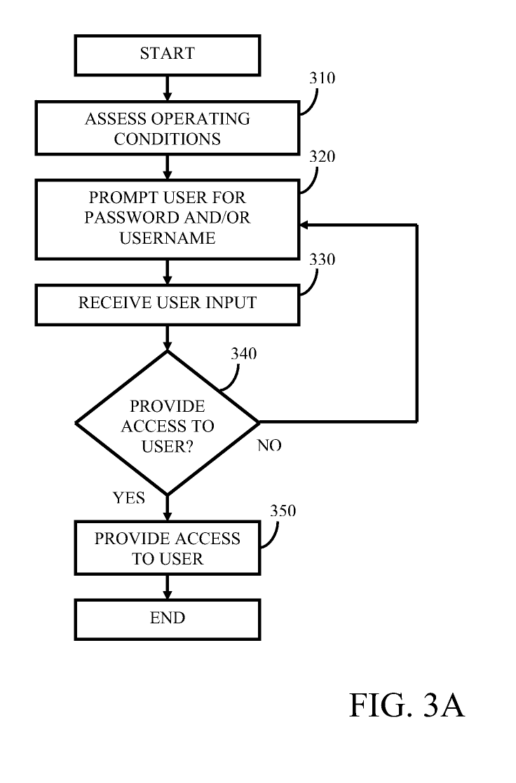

FIG. 2 shows a schematic depiction of the principle data flows within an operating system. As described herein, the operating system may include a collection of hardware components and/or software that may be used to carry out the various routines, methods, functions, and approaches described herein. For example, the operating system may reside locally on a client device, thereby not requiring a network or other remote devices. As another example, the operating system may include a combination of a client device, network, and remote server communicating with the client via the network.

Referring now to FIG. 2, a client user can provide a user input via client interface 284, which may include an input device of the client device described with reference to FIGS. 1A and 1B. The client user can utilize a security code selection tool 286 via the client interface 284 to create and/or select a security code including a password and/or username. The rules or parameters governing the creation or selection of the security code by the user can be set by an administrator via administrator interface 290. For example, the administrator can utilize the administrator interface to select the minimum string length that may be selected by the client user for a password and/or username, type of characters that may be used for the password and/or username as well as minimum security settings, etc. As described herein, an administrator may include a system administrator, a network administrator, a security administrator, or the client user in the case where the operating system resides locally at the client device. Note that the security code creation tool can be represented as a graphical user interface that may be displayed to the client user via a display device of the client device, represented in FIG. 2 as the client interface 284.

After a security code is selected by the client user, the security code or derivative information thereof can be stored in security code storage 292. As one example, the security code can be stored at the client device or at a remote server communicating with the client device. Further, the security code can be stored as an encrypted code. In some examples, the security code including a password and/or username can be stored along with a plurality security code variants that may be created by the security code selection engine responsive to the parameters set by the client user or administrator. The security code variants can represent variations of the security code that may be later entered by the client user to gain access. For example, the security code variants can represent error allowance that can be provided to the client user based upon the minimum security settings selected by the administrator or client user and the conditions of the original security code selected by the client user such as string length, type of characters, etc. Thus, in some examples, allowable or acceptable password and/or username errors can be stored in memory at the client device and/or a remote server to enable authentication of the client user at a later time. However, in other examples, the security code variants may be created only after the client enters a security code to gain access to requested information and services. In this way, the security code variants do not necessarily have to be created or stored before access is requested by the client.

After the client user has selected a security code, the client user may request access to security code protected information and/or services indicated at 294. In response to a request for access, the client user may be prompted to input their security code, including a username and/or password that was previously selected. As the client user enters their security code via the client interface (e.g. input device of their client device), the client user input can be received by a security code validation engine 288, which can read in the stored security code and/or security code variants (if any) from 292, where it may be judged if access should be granted to the client user. Note that the administrator via their administrator interface can set the operating parameters of the security code validation engine to enable some input errors to be made by the client user and still grant their requested access. For example, the administrator can select the type of error allowance that can be provided to the client user, based on their selected password, minimum security settings, etc.

If the client user input matches their selected security code or a security code variant (e.g. based on the types of error allowance permitted by the operating system) the client user can be provided the requested security code protected information and/or services indicated at 294. Alternatively, if the client user input does not match their selected security code, or if it exceeds the error allowance, then access can be denied to the client user.

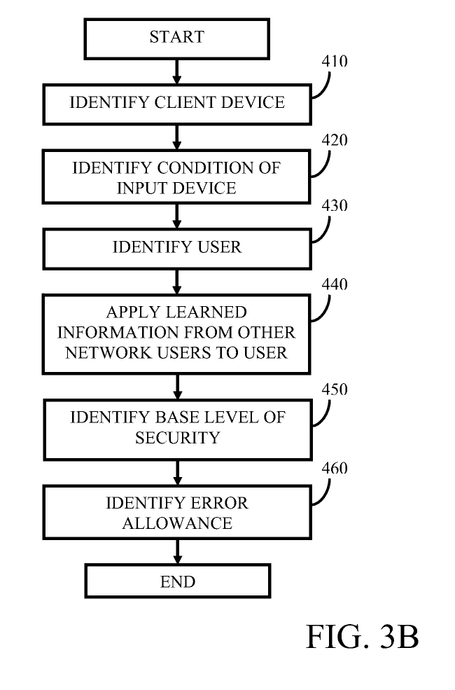

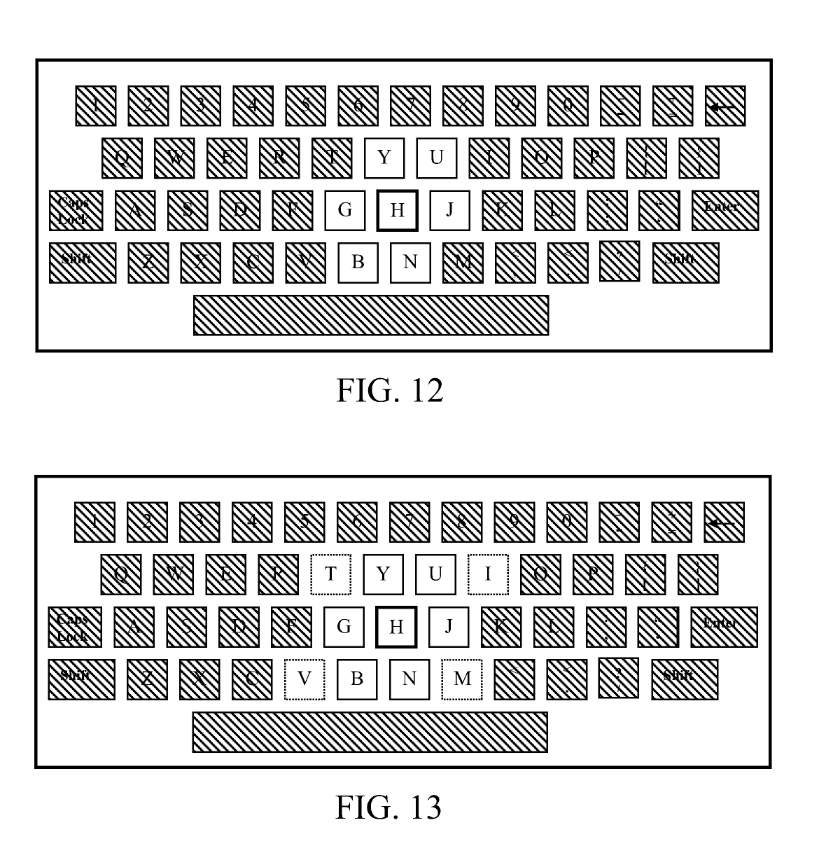

FIG. 3A illustrates a flow chart depicting a high level control method for providing secure access to a client user. Note that the access that may be provided to the user can include access to information and/or access to increased level of system or device control. At 310 the operating system may assess one or more operating conditions as will be described in greater detail with reference to FIG. 5. For example, the client device and/or server may assess one or more operating conditions including operating parameters previously set or selected by the client user and/or administrator. At 320, the operating system may prompt the user for a password and/or username. As one example, the user may be prompted to input a password and/or username via an input device such as a keyboard or keypad of the client device examples of which are shown in FIGS. 5 and 6. The prompt may be provided in response to a request for access to secure information initiated by the user. For example, the user may seek to access an email account, financial information, medical information, insurance information, personal information of the user, etc. or may seek to access an increased level of control such as administrative control of the client device and/or operating system. At 330, the user input including a password and/or username may be received by the operating system via the input device of the client device. For example, the client device and/or the server system can receive the user input via the input device. As one example, the user input may be transmitted from the client device to a server where it may be validated or may alternatively be validated at the client device as will be described in greater detail with reference to FIG. 11. At 340, it may be judged whether to provide the requested access to the user based on whether the user input agrees with a previously created or previously assigned password and/or username. As will be described in greater detail below, the user input may be compared to a stored value or values, where in some cases a user input containing one or more errors may be accepted if error allowance is applied. If it is judged at 340 not to provide access to the user based on the user input, then the control system may again prompt the user for another input. For example, the user input may have contained at least one error or may have a greater level of error than permitted by the system. For example, under some conditions, select password or username errors may be permitted as defined by the system administrator or client user. Alternatively, if the user input is acceptable, then the requested access may be provided to the user at 350. For example, the requested information or increased control may be provided to the user. Finally, the routine may end.

FIG. 3B illustrates a flow chart depicting an example routine that may be performed by the operating system, for example, when assessing operating conditions as described with reference to 310 of FIG. 3A. For example, the assessment of operating conditions may include one or more of operations 410-460. At 410, the client device may be identified, for example, via an IP address, user account, or other exchange of information that indicates the client device hardware and/or software including type, version, configuration, etc. Where the client device does not communicate with another external network device, the client device may be detected during an initialization period. At 420, one or more conditions of the input device of the client device may be identified, such as the type of input device, size, shape, the number of keys, proximity of the keys, configuration of the keys, the serial number, the model number, or other identification information. It should be appreciated that the term keys as described herein may include physical keys or keys that are represented graphically on a touch screen device, each of which enable the user to provide input to the client device.

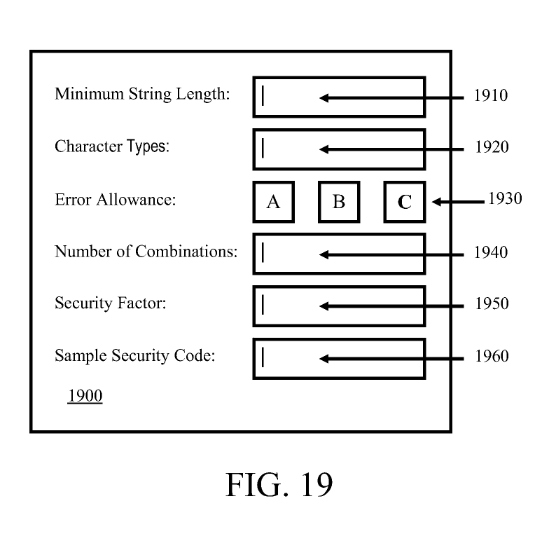

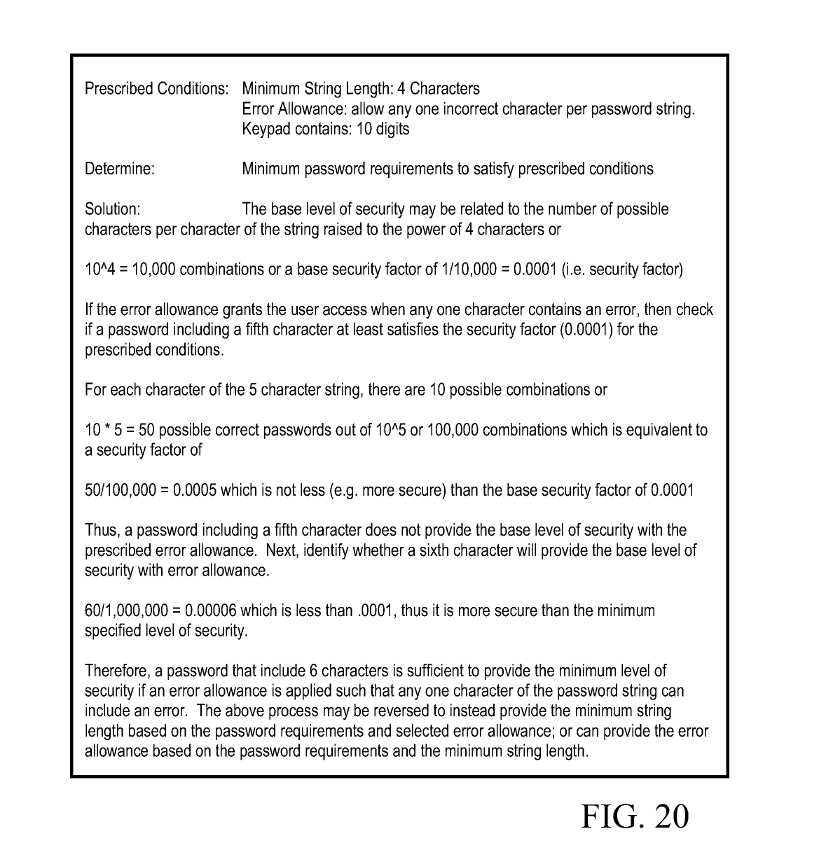

As will be described in greater detail below, information relating to the input device used by the user may be considered by the operating system when identifying an error allowance for the user. At 430, the user may be identified, for example, by the username and/or password, the client device used, the IP address, a security card (e.g. an ATM card), a key card or other key, etc. Again, as will be described in greater detail below, information relating to the user may be considered by the operating system when identifying an error allowance for the user. At 440, information relating to the activity of other users and their interaction with the operating system may be identified, where it may be used to identify error allowance. For example, input errors that are common among a particular client device or input device among a plurality of other users may be used to vary the error allowance applied to the user. In other words, common and/or uncommon errors may be identified from the network activity of a plurality of users that utilize similar and/or dissimilar input devices, whereby the common errors may be considered when identifying an error allowance for the user. As another example, the user's past activity including their personal input errors may be identified and used to select an error allowance. At 450, the operating system may identify a base level of security that must be maintained. This level may be set, for example, by a system administrator or the user as will be described with reference to at least FIGS. 19 and 20. The base level of security may be used to determine the level of error allowance that may be provided to the user. At 460, the error allowance provided to the user may be identified based on one or more factors and/or may be set by the user or system administrator, for example. These factors may include, a condition of the stored password and/or username created by or assigned to the user, the base level of security identified at 450, a condition of the user identified at 430, a condition of the client device and/or input device identified at 410 and 420, information from other users at 440, among other operating conditions as will be described herein. Finally, the routine may end.

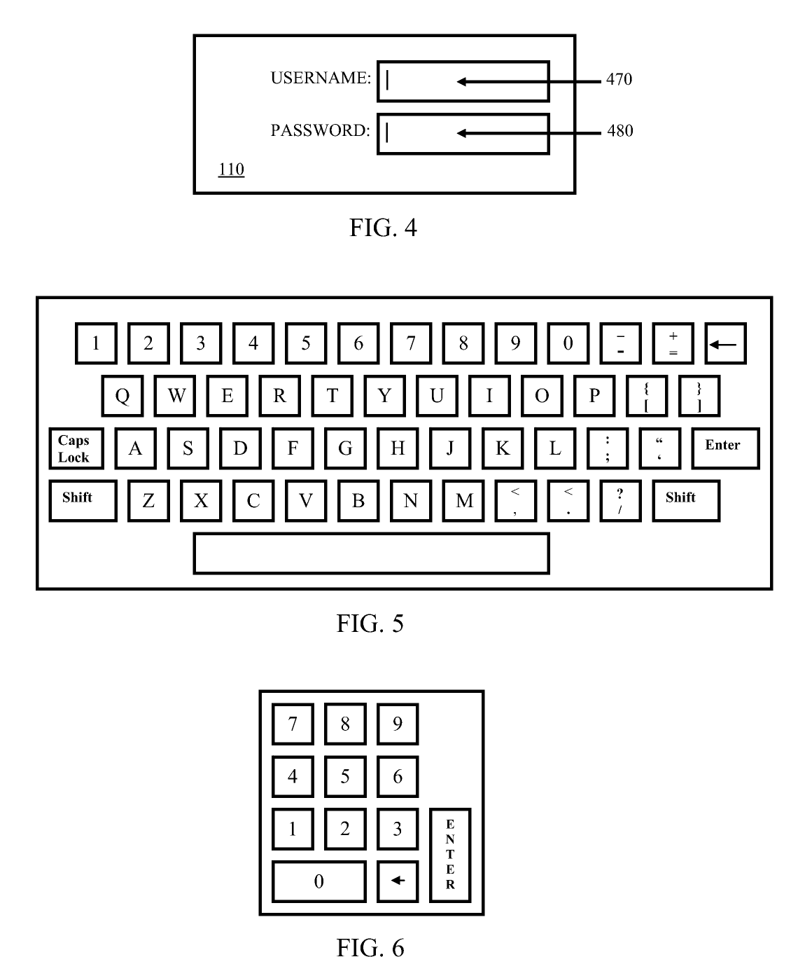

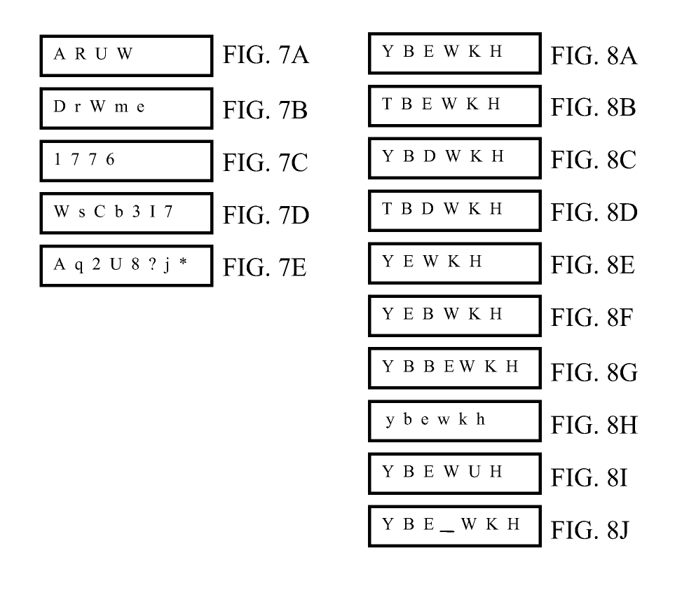

FIG. 4 illustrates an example of a graphical user interface that may be outputted by the client device 100 such as via display 110. The example of FIG. 4 may be a portion or the entire interface displayed by the device and may be executed via a web browser or other suitable software and/or hardware based program. In this example, a user may be prompted to input information (e.g. text, symbols, numbers, etc.) forming a password and/or username via an input device of the client device such as a keyboard or keypad. For example, the user may be prompted to enter a username into a username field indicated at 470 and/or a password into a password field as indicated at 480 via an input device. A similar prompting for a password and/or username can found in some current operating systems such as for providing a user login to a client device or to provide restricted access to user specific account information, among others. In some cases, the information entered by the user may be displayed in a corresponding field and may be obscured by a dummy text or symbols so that some of the entered information may not be visible to the user or other users. Further, as will be described in greater detail with reference to FIGS. 10A-10G, the user input may also be encrypted at the client device and/or decrypted at the server before validating the user input. Further, in some examples, a username, a password, and/or values indicative thereof may be stored at the server for validating a user input with or without the application of error allowance.

FIGS. 5 and 6 show example input devices such as a keyboard or keypad that may be included with or provided by the client device for enabling a user to enter information such as a username and/or password, among other input information. It should be appreciated that the input devices shown in FIGS. 5 and 6 are non-limiting examples of the various input devices that may be used and that any suitable input device may be used to enable a user to input information.

FIG. 4 shows an example keyboard that may be referred to as having QWERTY configuration. In particular, the keyboard of FIG. 5 includes keys for inputting English characters, numbers, symbols, and/or for performing various functions, however more or less keys may be provided as well as different keys in other examples. For example, the keyboard may include characters for a different language and/or may be arranged in a different configuration and/or may be of a different size. The lower key on the keyboard of considerable size relative to the other keys in this example represents a space bar. The enter key may be used to perform a next line function, to initiate a submission of information, and/or to make a selection. Further, a shift key is shown which may be used to select between a lower case and an upper case setting for one or more of the other keys when depressed, while a caps lock is shown that may be selected between the lower and upper case characters for a particular key. A delete key for performing a delete or backspace function is shown in the upper right corner of the keyboard.

FIG. 6 shows an example keypad that may be included with a client device for enabling a user to input information. As one example, the keypad of FIG. 6 may be included with a client device such as an ATM or mobile phone or may form part of a larger input device. The keypad of FIG. 6 is shown including keys for entering numbers, a delete key for performing a delete or backspace function, and an enter key for submitting information and/or performing a selection. Further, the keypad may include more or less keys, in some examples. It should be appreciated that the various input devices described herein may be embodied as a physical device or may be provided to the user via a display of the client device. Where the input device is provided via a display, a user may, for example, select a key from the displayed keyboard by touching the display (in the case of a touch screen display) or in some cases may use a device such as a controller, mouse, joystick, etc. to move a cursor icon to the key on the display where it may selected. Thus, it should be appreciated that the various approaches described herein are not necessarily limited to keyboards or keypads that are mechanically operated by a finger or appendage of a user, but may also may apply to those displayed to a user via a display device.

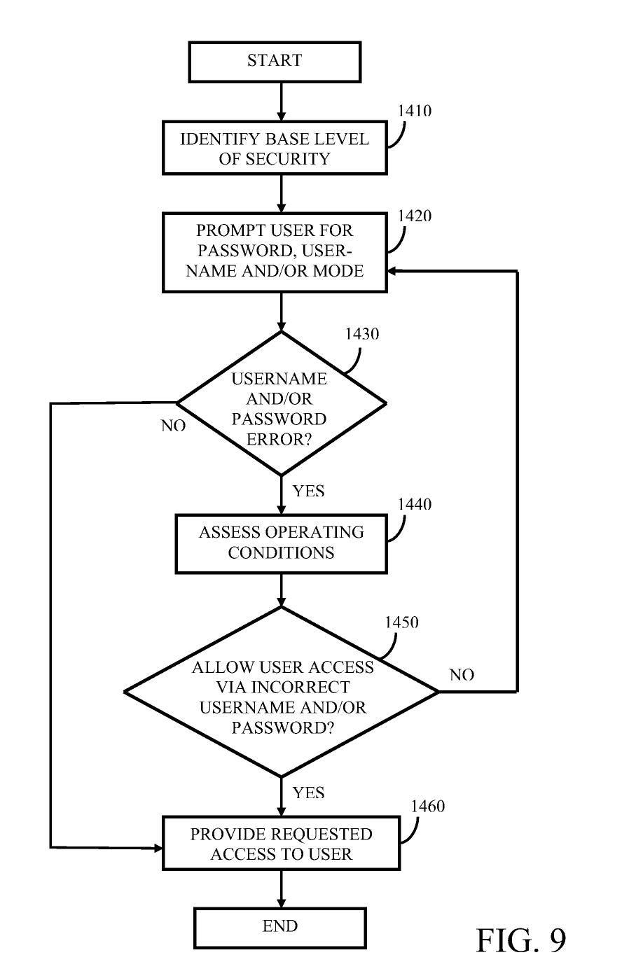

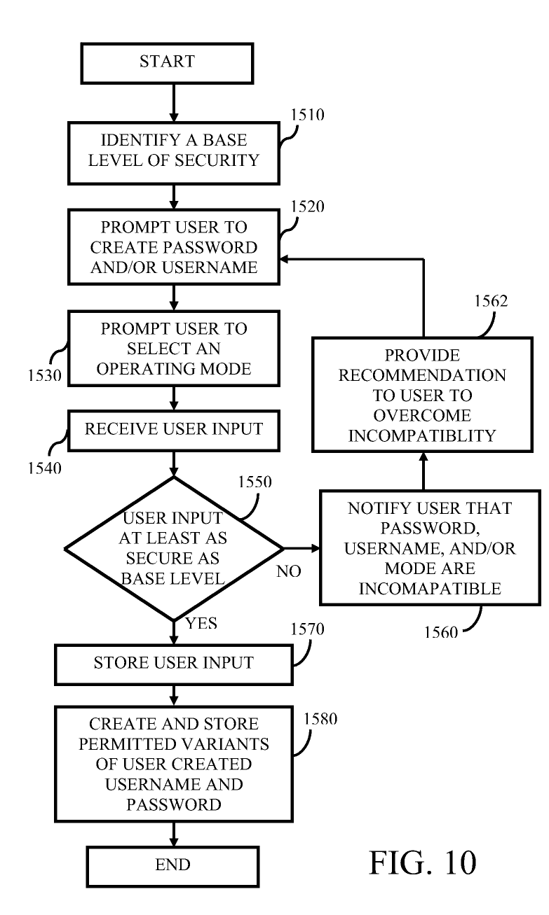

FIGS. 7 and 8 show examples of information that may be entered by a user via an input device such as the keyboard of FIG. 5 and keypad of FIG. 6. As one example, FIGS. 6A-6E illustrate various types of information that may be used to represent a password or username for enabling a user to gain access via the client device. FIG. 7A shows an example string having a string length of 4 characters including upper case alphabet characters as “A R U W”. FIG. 7B shows another example string having a string length of 5 characters including upper case and lower case alphabet characters as “D r W m e”. FIG. 7C shows another example string having a string length of 4 characters including numerical characters as “1 7 7 6”. FIG. 7D shows another example string having a string length of 7 characters including upper case and lower case alphabet characters, and numerical characters as “W s C b 3 I 7”. FIG. 7E shows another example string having a string length of 8 characters including upper case and lower case alphabet characters, numerical characters, and symbol characters as “A q 2 U 8 ? j *”. Thus, a user may input information (e.g. a password or username) including a string of one or more alphabet characters, numerical characters, and/or symbols via an input device of a client device.

As one example, a user may be prompted to input a username represented by a first string and a password represented by a second string by pushing, touching, selecting or striking one or more of the keys of the input device such as the keyboard or keypad of FIGS. 4 and 6. In some cases, during input via an input device, a user may make an input error by improperly selecting a key either intentionally or unintentionally, or may select an incorrect key. FIGS. 8A-8J show various examples of errors that may occur as the user inputs information such as a password and/or username.

FIG. 8A illustrates an example of correctly entered string that may be used for comparison with the incorrect or error strings of FIGS. 8B-8J. The strings illustrated by FIGS. 8B-8J may be referred to as string variants of the string of FIG. 8A. The variants may represent a password variant or username variant that may be accepted or rejected by the operating system based on a comparison to the password or username created by or assigned to the user and a level of error allowance permitted by the operating system. Thus, the examples of FIGS. 8B-8J not only represent variants of FIG. 8A, but when compared to FIG. 8A also represent different types or levels of error allowance that may be permitted or tolerated by the operating system.

FIG. 8A shows a string having a string length of 6 characters and including upper case alphabetic characters as “Y B E W K H”. It should be appreciated that the correct reference string of FIG. 8A is merely an example and that strings may be of any suitable length and/or contain any suitable character type. For example, a string length may include between 1 character and 100 or more characters depending on the level of security requested by the system administrator and/or user. As another example, in present password and username applications a common string length may include between 4 and 8 characters. Further, it should be appreciated that these strings may represent a password or username as created by the user or assigned to the user by the operating system, and that these strings may be encrypted, modified, decrypted, etc. during validation, transmission or other operation that enables the user to be granted their requested access.

FIG. 8B shows a string illustrating an input error of the first character of the string where the “T” character was selected by the user rather than the “Y” character as shown in FIG. 8A. In this example, the “T” key is located adjacent the key for entering the “Y” character in the case of entry via the keyboard of FIG. 5. Thus, in some examples, this input error may result from a key selection error such as a misplaced finger or confusion between keys, etc. FIG. 8C shows a string an input error of the third character of the string where the “D” character was selected rather than the “E” character as shown in FIG. 8A. FIG. 8D shows a string illustrating multiple input errors of the first character of the string where the “T” character was selected rather than the “Y” character and the third character of the string where the “D” character was selected rather than the “E” character as shown in FIG. 8A. FIG. 8E shows a string illustrating an input error where a character of the string was omitted or entry of the character was skipped such as the “B” character of the second character position as shown in FIG. 8A. FIG. 8F shows a string illustrating an input error of the second and third characters of the string where the order of the “B” and “E” characters were inverted or reversed as compared to the reference string shown in FIG. 8A. FIG. 8G shows a string illustrating an input error where multiple key strokes of a key was performed such that the “B” character was repeated as compared to the reference string shown in FIG. 8A. FIG. 8H shows a string illustrating an input error where an incorrect case selection was performed (e.g. via a caps lock selection and/or shift button selection) such that the entire string or a portion of the string includes characters of the improper case (where case sensitivity is involved) as compared to the reference string shown in FIG. 8A. FIG. 8I shows a string illustrating an input error of the fifth character of the string where the “D” character was selected rather than the “K” character as shown in FIG. 8A. In this example, the key for entering incorrect character “D” is not located adjacent the key for entering “K” where the string was entered via the keyboard of FIG. 5 in contrast to the error described above with reference to FIG. 8B. As will be described in greater detail, the proximity of an incorrect key stroke with reference to the position of the correct key may vary how the client device is operated (e.g. whether access is granted) and whether error allowance enables access to be granted to the user. FIG. 8J shows a string illustrating an input error where a space was inserted between character “E” and character “W” as compared to the string shown in FIG. 8A. Further, other errors or mistakes may be made by a user including combinations of the above described input errors, including more or less input errors, or others.

An example scenario will be described for illustrating a potential situation that may occur when a user attempts to access via the client device. A client may operate the client device to access information where the information may include any suitable information that may be outputted by the client device including financial information, personal information, etc. In some examples, access to at least a portion of the information may be restricted to users having an access key or code. As one example, a user may be prompted to enter a username and a corresponding password, for example, as described above with reference to FIG. 4. In the case where the username and password are correctly entered by the user (e.g. via a keyboard or keypad), access to the restricted information and/or other restricted control feature (e.g. administrative control for the client device, etc.) may be granted.

Alternatively, with existing systems, in the case where the username and/or password are incorrectly entered, such as by one or more of the input errors described above with reference to FIG. 8, then the user may be denied access to the restricted information and/or restricted control function. In another approach, as set forth herein by the inventor of the present disclosure, in some conditions, where a username and/or password are incorrectly entered, the user may be granted access.

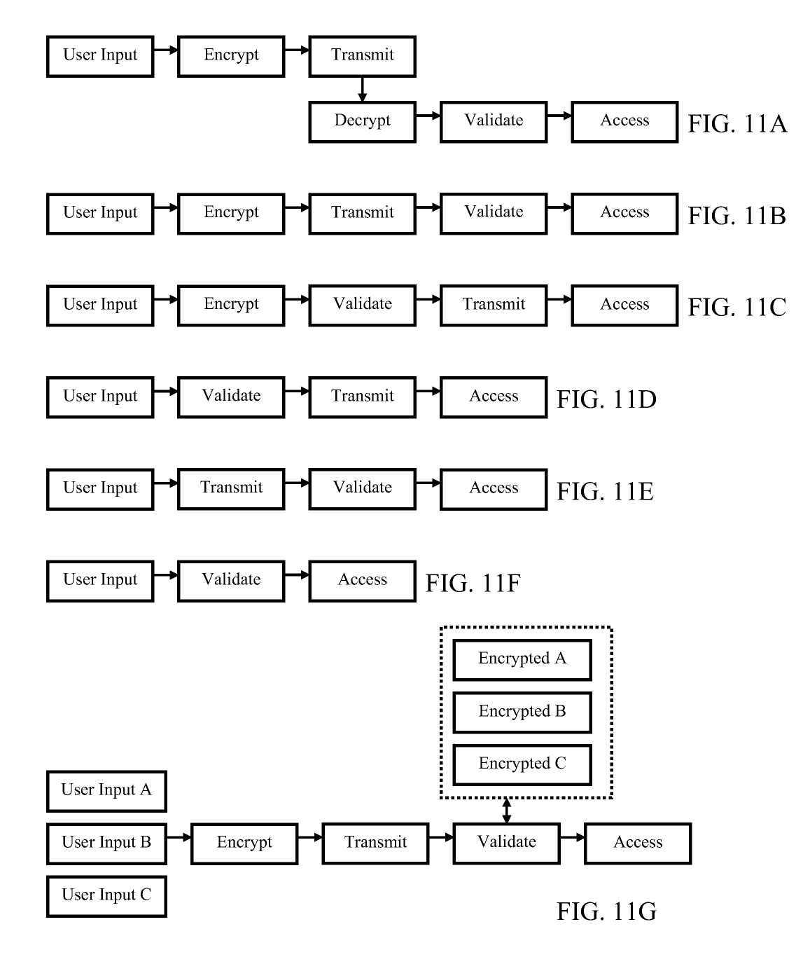

FIGS. 9 and 10 illustrate example routines that may be performed by the operating system including one or more of the client device 100 and/or server 140 communicating with client device 100 via network 130. Note that the routine may be performed by the client device and/or server in response to computer-readable code stored in memory of the client device, server, or other device communicating with the client device.

Referring to FIG. 9, at 1410, a base level of security may be identified. This may include determining a minimum level of security for password and/or username based access to restricted information and/or restricted control functions. As one example, a minimum string length may be required by the operating system (e.g. as selected by the system administrator and/or user) for accepting a password and/or a username. As another example, the type and/or quantity of characters accepted for each character of the string may be identified. Further, a factor or based level of security may be identified which may be used to direct the requirements of the password and/or username for use by the operating system. These requirements may include a minimum string length for the password and/or username, the quantity and type of characters accepted, types of errors allowed (e.g. error allowance), etc. As described with reference to FIGS. 19 and 20, the administrator or client user may select the base level of security utilized by the operating system.

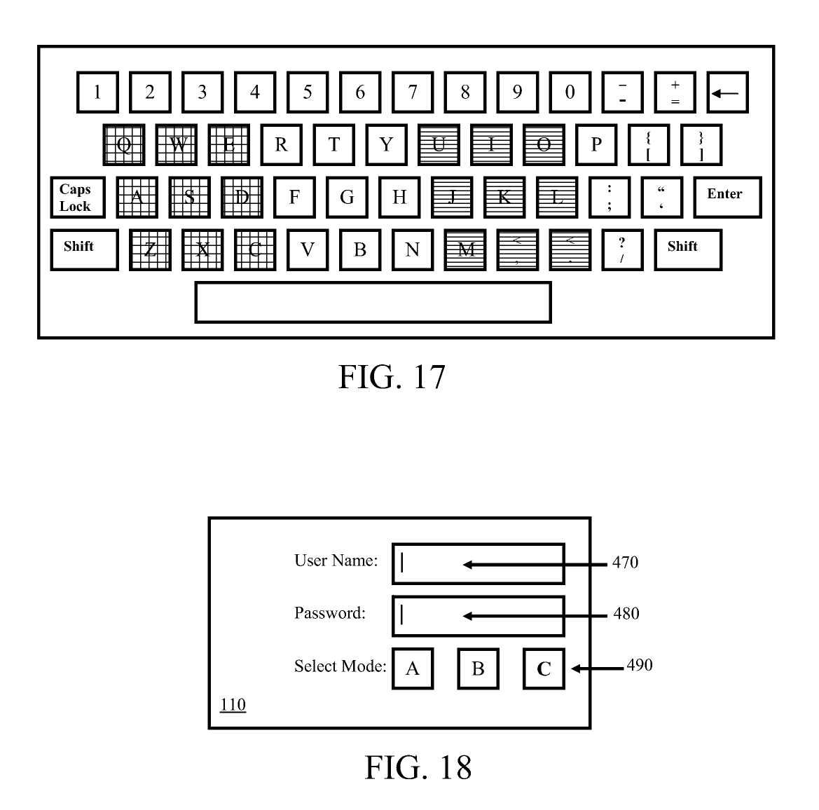

At 1420, the client user may be prompted to enter a password, a username, and/or select a mode of operation. In this example, the username and/or password have been already created by the user or assigned to the user. The routine described with reference to FIG. 10 includes a method for enabling a user to create a password and/or username. As described above with reference to FIG. 7, a username and/or password may include a string of one or more characters where the characters may include alphabet characters (upper case and/or lower case), number characters, and/or symbol characters. Further, as will be described in greater detail below with reference to FIG. 18, the user may be prompted with an opportunity to select a mode of operation. For example, a first mode may be selected by the user to cause access to be granted to the user only if the password and username include no input errors (e.g. consists of only a correct string of characters). This may be referred to as a mode that does not include error allowance. A second mode may be selected by the user to cause access to be granted if the entered password and/or username include a first level of input error (e.g. one or more incorrect characters of a string). Thus, a first level of error allowance may be enabled. Further, in some embodiments, a third mode may be selected by the user to cause access to be granted if the entered password and/or username include a second level greater than the first level of input error. Thus, a second greater error allowance may be enabled. However, in some embodiments, a user may not be prompted to select an operating mode and may only be prompted for a username and/or password. Instead, the error allowance may be assigned by the operating system based on the operating conditions such as the base level of security identified and the password created by the user and as directed by the administrator.

In some embodiments, a user may be prompted to select between two or more modes based on a level of security identified at 1410 and/or a condition of the stored correct username or password created for the user. As one example, a system using a first base level of security may not prompt a user to select a mode that enables an incorrect password to be entered, while a system using a second base level of security lower than the first base level of security may prompt the user to select a mode that enables one or more input errors of the password and/or username. For example, a higher security password based access system may require exact agreement of the entered password and/or username, while a lower security password based access system may not necessarily require exact agreement of the entered password and/or username and an assigned password and/or username, and may be therefore allow the user to select between at least the first mode and the second mode identified above. However, it should be appreciated that use of error allowance does not necessarily require that security be reduced, but instead the password and/or username requirements may be increased, as will be described in greater detail below.

At 1430, the username and/or password entered by the user at 1420 in response to the prompt may be validated at 1430. For example, the username and/or password may be compared to stored values, where it may be judged whether the username entered by the user agrees with the stored value for the username and/or whether the password entered by the user agrees with the stored value for the password. Thus, at 1430, it may be judged whether the username and/or password include an error. If the answer at 1430 is no, the requested access may be provided to the user at 1460. Alternatively, if the answer at 1430 is yes, the operating conditions may be assessed at 1440 before determining whether to allow access via the incorrect username and/or password.

The operating conditions assessed by the operating system may include the level of error allowance, the base level of security identified, the user input, the password and/or username assigned to the user, among other conditions. Note that the base level of security can be selected based on a number of possible combinations of the security code for a given set of security code operating parameters including string length, type of characters, error allowance, etc. FIG. 20 provides an example

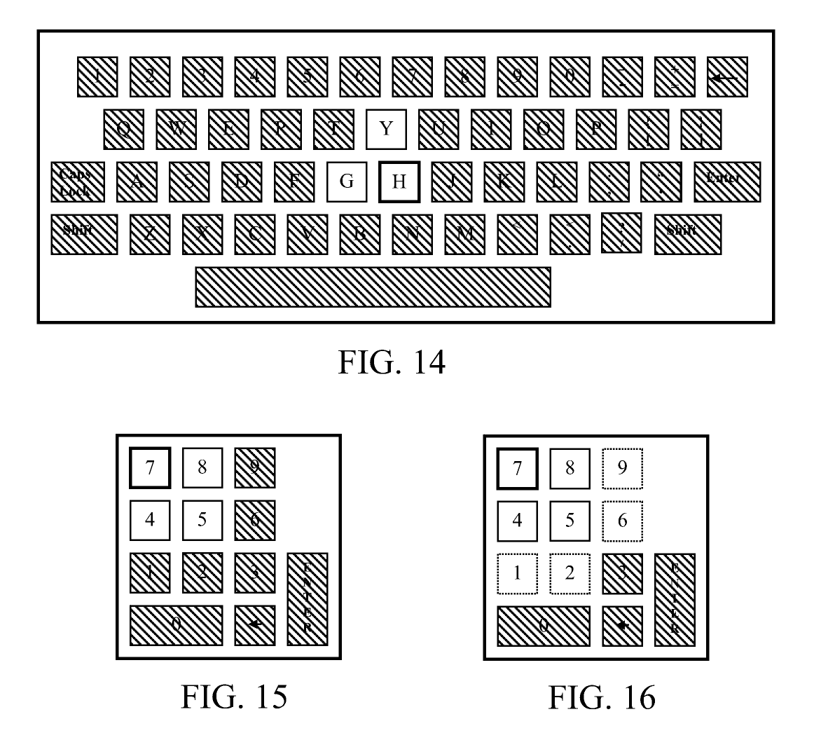

In some embodiments, the input device (e.g. keyboard, keypad, etc.) being used by the user to input information (e.g. password and username) may be detected and a value stored in memory based on the detected input device. By detecting the type of input used by the user, the operating system may be able to determine the configuration and/or size of the input device, thereby enabling some user input errors to be handled differently than other input errors. In this manner, a more informed decision on what level of error allowance is suitable based on the keyboard configuration. For example, as will be described in greater detail with reference to FIGS. 12-17, some input errors by the user may still enable access by the user while other input errors may require that the user re-enter at least one of a password and/or a username to gain access.

In some embodiments, a client device receiving a user input via a first keyboard may be assigned a first level of error allowance based on the relative size and/or configuration of the first keyboard, while a second keyboard of a substantially smaller size or different configuration than the first keyboard may be assigned a second level of error allowance greater than the first level of error allowance, since a user may be more prone to generate errors with a smaller or differently configured keyboard. In this manner, a consideration of the input device utilized by the user may be used to vary the error allowance assigned by the operating system.

If the answer at 1450 is no, the user may be again prompted for at least one of a username and/or password at 1420. For example, if an incorrect password was entered, then the user may be again prompted for the password. In some embodiments, if a correct username or password are entered correctly and the other of the username and password are entered incorrectly, then the user may only be prompted with the incorrect of the username or password. However, in some embodiments, a user may be again prompted for the username and password in response to a single error. In other embodiments, the user may not be prompted for a username, where only a password is sufficient to enable access.

If the answer at 1450 is judged yes, the requested access may be provided to the user at 1460. Finally, the routine may end.

The above described routine provides an example where an incorrectly entered username and/or password can enable a user access based on an identified base level of security and operating conditions including an assessment of the number of combinations of the password and/or username string length as well as the type and/or magnitude of the error, and/or the level of error allowance used. FIG. 10 provides a non-limiting example of a routine that may be performed to create a username and/or password. At 1510, a base level of security may be identified. As described above, the base level of security may be used to drive the password and/or username minimum requirements as well as identifying a level of error allowance that may be used. As one non-limiting example, a base level of security may be identified as a password of a minimum string length of 4 characters with each character of the string including only number characters, such as is used with some ATMs, where an identification card may also serve as a username or password.

At 1520, the user may be prompted to create a password and/or username. In some embodiments, the user may be informed via instructions displayed on the client device of certain requirements for the creation of the password and/or username, which may be a function of the base level of security. To continue with the password minimum string length of 4 characters in the example above, the instructions provided to the user (e.g. via the display of the client device) may include an indication that the minimum password string length is at least 4 characters. In some embodiments, the user may be notified of the minimum string length for a first level of error allowance and a second minimum string length greater than the first string length that may enable a second greater level of error allowance. For example, the user may be notified (e.g. via instructions provided during password and/or username creation) that a four character password string is the minimum requirement, but if the user creates a password having at least six characters then the six character password may be eligible for password error allowance (e.g. one or more errors in the entered password during a later request for access).

At 1530, the user may be prompted to select an operating mode, which may be used to enable the user to set the level of error allowance for subsequent access via the password and/or username. In some embodiments, a user may only be prompted to select an operating when the password and/or username created by the user is greater than the base level of security identified at 1510. As one example, if the base level of security identified at 1510 is 6 characters of upper and lower case alphabetic characters and numbers, and the user creates a password having 7 characters (i.e. one character more than required by the base level of security), the user may be prompted to select between a first operating mode having a first level of error allowance (e.g. no error is allowed) and a second level of error allowance greater than the first level (e.g. one or more errors may be allowed). Alternatively, if the user creates a password or username that includes 6 characters (e.g. the base number of characters of this example), then the user may not necessarily be prompted to select between operating modes, since any error allowance may result in a level of security less than the identified base level of security.

Further still, if the user alternatively creates a password and/or username that includes even more characters (e.g. 8, 9, 10 or more) that results in an even higher level of security than the base level, then the user may be prompted to select between two or more operating modes having varying levels of error allowance, while maintaining that the selected error allowance does not result in a level of security less than that which is identified at 1510. In some embodiments, a user may not be prompted to select an operating mode, but instead a level of error allowance may be assigned to the user account based on the level of security provided by the password and/or username that were created by the user. For example, if a base level of security is set to 6 number characters and the user creates a password and/or username having 10 characters each, then a level of error allowance may be assigned such that subsequent errors in password and/or username input may be accepted and access may be granted without creating a condition where a less than identified level of security occurs.

As another example, a user may be first prompted to select between at least a first level of error allowance and a second level of error allowance, where upon the selection is performed, the user is then notified of the minimum requirements for the password and/or username for the selected level of error allowance, thereby maintaining the base level of security identified for the operating system.

Further, it should be appreciated that a different level of security may be identified for the username and password. For example, a first level of error allowance may be assigned to or selected for a password while a second different level of error allowance may be assigned to or selected for a username. At 1540, the user input may be received by the client device and evaluated by the operating system at the client device and/or server, etc. For example, at 1550, it may be judged whether the user input including one or more of a password to be created, a username to be created, and selected operating mode provide at least the base level of security identified at 1510. If the answer is no, then the user may be notified at 1560 that at least one of the username, password, and/or selected operating mode are incompatible with the identified level of security. From 1560, the routine may return to 1520 where the user may change or resubmit a new password, username, and/or operating mode so that the identified level of security is achieved.

In some embodiments, when a password and/or username are created, the string representing the password or username may be stored by the operating system. In some examples, the stored string may be encrypted, coded, or modified before being stored in alternate form. In some examples, the creation of a password or username result in the operating system creating derivative or variant passwords or usernames in response to the level of error allowance selected. For example, if an error allowance is used that enables any key surrounding the correct key to provide access, then a password variant may be created for each of the combinations of the allowed keys. Further these variants may be encrypted and/or stored for validating subsequently entered passwords having the correct string or a string including at least an error.

Alternatively, if the answer at 1550 is yes, the user inputs including the created password, created username, and/or selected operating mode may be stored in memory or other storage medium at the client device or other device in communication with the client device for subsequently validating user password and username submissions as well as for determining whether access should be granted based on the assigned or selected level of error allowance. As will be described below in greater detail, the username, password, and/or selected operating mode may be stored as computer readable code and may be encrypted or not encrypted.

FIGS. 11A-11G illustrate some non-limiting examples of how a user input such as one or more of a password, username, and/or operating mode selection may be used to enable access of restricted information and/or a restricted control operation by a user. FIG. 11A shows an example where a user input (e.g. via an input device such as a keyboard or keypad) may be first encrypted at the client device before it is transmitted to a device external the client device such as a server communicatively coupled to the client device via a network. Next, the server may decrypt the user input before it is validated as described above, for example, by comparing the user input to the corresponding stored input (created password and/or username) and error allowance. If the user input is validated, then the user may be granted access, for example, by the server transmitting the desired restricted information and/or restricted control operation to the client device where it may be outputted and/or performed.

Alternatively, as shown in FIG. 11B, a user input may be encrypted, transmitted, and validated without decrypting the user input. For example, a password and/or username may be encrypted when it is created (e.g. as described above with reference to FIG. 10) where the encrypted username and/or password is stored for later comparison to the encrypted user input. Again, if the user input is validated based on a comparison and/or operating conditions such as the error allowance, user input, and/or identified level of security, then the user may be granted access.

As shown in FIG. 11C, the user input may be encrypted and validated at the client device by comparing to a stored encrypted username and/or password and/or transmitted from the server where it is stored to the client device for validation. If the user input is validated, a request for access may be passed to the server where the requested content may be transmitted from the server to the client device.

As shown in FIG. 11D, the user input may be validated at the client device without being encrypted (e.g. via a comparison between the user input and stored information at the client device or server). A validated user input may then transmit a data request to the server where the requested information may be returned to the client device for presentation to the user.

As shown in FIG. 11E, the user input may be transmitted to the server without being encrypted where it may be validated and access may be granted.

As shown in FIG. 11F, the user input may be validated at the client device and the user may access information or control operations at the client device without requiring communication with an external device. For example, a password for accessing or logging onto the client device may be validated at the client device based on a stored string (either encrypted or non-encrypted) and/or variants of the string (either encrypted or non-encrypted).

FIG. 11G shows an example where one of a plurality of user inputs A, B, and C (e.g. one or more error strings) may be entered at the client device, where it is encrypted, transmitted, and validated based on one of a plurality of stored encrypted strings A, B, and C at the server before access is granted. As one example, the plurality of user inputs A, B, and C may represent the various permutations of a certain level of error allowance. In other words, user input A may represent a first password (the correct password) and user inputs B and C may represent variants (e.g. due to user errors during input) of the correct password that may also enable access. Further, the server may store a separate encrypted password for each of the possible permutations of passwords based on the level of error allowance, or the server may store a single encrypted password (e.g. a master password) that may be sufficient to validate each of the plurality of user inputs that may be used to achieve access. Still further, it should be appreciated that the operating system may use look-up tables or mathematical functions to validate a password having an error without necessarily storing every combination of the acceptable error passwords.

It should be appreciated that FIGS. 11A-11G are non-limiting examples of the many possible ways of validating a user input and that other configurations are possible. For example, with reference to FIG. 11G, a client device may alternatively store the master password for performing validation of each of a plurality of password variants that enable access or the server may store a non-encrypted master password for validation of a non-encrypted password variant. Regardless of the configuration for performing the validation, it should be appreciated that the present disclosure relates at least to enabling access by the user when a user input such as a password or username are incorrect based on a previously created password or username.

FIGS. 12-17 illustrate examples of how error allowance may be implemented in practice. For example, FIG. 12-14 and FIG. 17 show the keyboard of FIG. 5 for illustrating different input error scenarios. For example FIG. 12 shows a key “H” that may be referred to as the correct key, expected key or target key of a password or username string. The “H” key may be selected by the user to input the final character of the string shown in FIG. 8A, for example. During an operating mode where no error allowance is selected or assigned, the “H” key may be the only key stroke for enabling a validation of the user input. For example, the “H” character may be one of a plurality of characters in a password string. Thus, during a no error allowance mode, only the “H” key may be selected. However, during a different mode, where there is some level of error allowance, one or more other keys such as the keys adjacent to the “H” key on the keyboard may provide access to the user. In the case of the specific “H” key example, other key strokes such as “Y”, “U”, “J”, “N”, “B”, and “G” may be accepted and validated to permit access.

FIG. 13 shows an example similar to FIG. 12, except where additional keys of a greater distance or range from the “H” key are accepted and validated to permit access. For example, “M”, “I”, “T”, and “V” may be accepted. Thus, as described above, the level of error allowance may be varied in response to base level of security identified and a level of security provided by the password created by the user. In some embodiments, however, a single error allowance may be used for passwords and/or usernames of any suitable length and/or level of security, and may be applied similarly or differently across a group of different users. In some embodiments, an error allowance may be provided that any key stroke and corresponding character may be used to replace any one or more characters of the correct string.

FIG. 14 shows how some keys may be validated based on common or learned user errors. As one example, FIG. 14 again shows how the “H” key may be the target key for representing a character of a password or username string. It has also been recognized by the inventor of the present disclosure that a particular hand or finger position of a keyboard may result in a particular set of errors. For example, as the first finger of the right hand of a user moves from the initial position (e.g. of the home row) above the “J” key to strike the “H” key, the first finger may overshoot the “H” key and instead strike the “Y” or the “G” key, as one example. Thus, the number of acceptable key strokes for purposes of error allowance may be reduced by identifying or learning common typing errors while reducing error allowance for keys or combinations of keys that provide less common errors. For example, the “G” key may be the source of an error more often than the “Z” key when the target key is the “H” key. Therefore, in some conditions, where the “H” key is the correct key for a character of the user password, the “G” key may be accepted while the “Z” key may be objected to, for example, by denying access. In this manner, at least one factor of error allowance may include proximity and/or configuration of an error key with reference to the target key.

Errors may be learned on a user specific basis where they may be stored in memory at the client device and/or at the server or other remote device of the operating system. In some embodiments, the learned errors may be translated into password variants that may be accepted when entered by the particular user that the errors were learned from. Thus, password variants may be created and stored in memory of the operating system in addition to or as an alternative to the learned errors. Further, errors may be learned for a plurality of users that interact with a common portion (e.g. a remote server) of the operating system via the same client device or different client devices. The errors learned over a plurality of users may be shared between one or more of the users to facilitate greater learning of errors and increase the efficiency of the error allowance. In other words, it may be desirable to provide the highest level of error allowance for the lowest reduction in the level of security. The efficiency of the error allowance may be increased by reducing the number of allowed password or username variants that are less relevant based, for example, on the particular operating conditions such as the particular user/keyboard interaction. The learning of errors may facilitate this reduction of acceptable password or username variants by providing the operating system with a data for distinguishing errors that are more probable from errors that are less probable based on the operating conditions.

Thus, by detecting the operating conditions, the learned errors or other learned information may be used to enable further increases in error allowance while minimizing reductions in the level of security provided. Operating conditions such as the type of user input device (e.g. keyboard, keypad, etc.) may be detected and compared with learned errors to facilitate greater efficiency of error allowance. For example, input errors may be learned for a first user, wherein the type (e.g. configuration, size, shape, model number, etc.) of the keyboard used by the first user may be learned as well. The operating system may then vary the error allowance provided to a second user based on the keyboard used by the second user. For example, if the keyboards used by the first and the second users are similar, the errors learned by the first user may be used to increase or reduce the number or type of password variants that may be accepted for the first user.

As another example, the IP address or other user/client device specific information may be identified by the operating system in addition to learning errors. By identifying the particular user or client device, the operating system may be able to vary the error allowance provided to the user/client device based on learned errors specific to that user or operating system. For example, the error allowance provided to a specific client device may be varied based on the IP address of the user. In the case of ATMs, the user's card may serve to identify the user so that errors learned for the particular user may be used to identify the type or number of password/username variants that will be accepted. In the case of cell phones or PDAs, the device itself may serve to notify the operating system of the user and thereby provide a particular error allowance specific to the user. In this manner, user specific information such as IP address, a card, or even the client device itself may be used to identify the user and provide a user specific and/or client device specific error allowance, thereby further increasing the efficiency of the error allowance by enabling more relevant password and username variants to be accepted.

FIGS. 15 and 16 provide examples for a numeric keypad as was described above with reference to FIG. 6. In the example of FIG. 15, the “7” key shown as the target key may also include adjacent keys “4”, “5”, and “8” for validating the string and enabling access to the user. FIG. 16 provides an example where a larger radius of error is provided with reference to the “7” key as the target key. Thus, in some respects, the level of error allowance as shown in FIG. 16 is greater than the level of error allowance shown in FIG. 15, since a great degree of error is allowed where more keys of a greater distance from the target key are allowed.

FIG. 17 provides an example of how portions of a keyboard or keypad may be divided into zones or regions. In this example, any one of the keys in a first region (e.g. Q, W, E, A, S, D, Z, X, C) may be used to provide a first user input while any one of the keys in a second region (e.g. R, T, Y, F, G, H, V, B, N) may be used to provide a second user input. Further, a third region (U, I, O, J, K, L, M, <, >) or other regions may be used to provide other inputs. In this manner, a user may be able to input information via a client device where it may otherwise be difficult or impossible due to specific conditions of the user and/or client device. For example, a person who has limited use of an appendage or is missing one or more appendages may be able to input information such as a password or username without necessarily requiring the ability to have key specific accuracy. Thus, in this example, a user may be able to enter a string (e.g. for a password) including combinations of at least a first input comprising any key of a first set and a second input comprising any key of a second set. Where such an approach is used, the system requirements of the length of the password string and/or username may be increased to provide the desired level of security.

As one example, even a binary code may be developed where the first input includes keys of a first half of the keyboard and the second input includes keys of the second half of the keyboard. The length of the binary code may be increased with reference to strings using a greater number of possible characters in order to maintain a desired level of security. It should be appreciated that any input device may be divided into any suitable number of regions for enabling a user to input a password and/or username string and that requirements on string length or error allowance may be varied accordingly to provide the desired level of security.

FIG. 18 illustrates an example of a graphical user interface that may be outputted by the client device 100 such as via display 110. In contrast to the example shown in FIG. 4, a user may be prompted to input a username, password, and/or select one of a plurality of operating modes shown at “A”, “B”, and “C”. In particular, an output similar to FIG. 18 may be used to facilitated operations 1520, 1530, and 1540 described above with reference to FIG. 10. As one example, a user may select mode “A” to set the level of error tolerance to a level where a submitted password and/or username containing any errors may not enable access. Alternatively, the user may select mode “B” or mode “C” to provide varying levels of error allowance to one or more subsequent user input operations including input of the password and/or username. For example, the mode selected by the user may be stored in memory of the client device or server, etc. to provide a desired level of error allowance to the user input for subsequent logins by the user.

FIG. 19 shows an example graphical user interface (GUI) of the administrator interface described herein. The example GUI 1900 of FIG. 19 can be provided to an administrator or client user via a display device. GUI 1900 can enable the administrator or client user to set the security parameters of the operating system that drive the security code creation tool and the security code validation engine described with reference to FIG. 2. While more inputs or different inputs may be provided in other examples, in this particular non-limiting example, the administrator (or client user) can input a minimum string length at 1910 that represents the minimum number of characters that may be selected for a password or username. A character types field indicated at 1920 may be provided to enable the administrator to select the types of characters that may be contained in the security code. Character types may include letters, numbers, and symbols that may be selected by the administrator for use as a security code character by the client user. The various error allowance selections indicated at 1930 can be used by the administrator to select different levels of error allowance including those described with reference to FIG. 8 as well as others or combination thereof. The possible combinations field indicated at 1940 can be provided to enable the administrator to input a total number of security code combinations that are to be utilized by the operating system. The security factor field indicated at 1950 can enable the administrator to input a security factor, which can be represented by the inverse of the total number of security code combinations. Note that the security factor or number of combinations fields can represent the “minimum security level” selected by the administrator. A sample security code can be inputted by the administrator at 1960 to enable testing of various combinations of security codes, error allowance, security factors, etc. Regardless of the particular fields that are provided to the administrator by GUI 1900, the administrator can provide input to only a portion of fields 1910-1960, whereby the operating system can provide the relevant information to the other fields. For example, GUI 1900 can serve as a security code calculator, whereby the administrator can input a desired security factor (or number of combinations), an error allowance selection, a minimum string length, and character types and receive an output of a sample security code or sample security code parameters via field 1960 that would satisfy the input conditions. As another example, GUI 1900 can enable the administrator to input a security factor, a minimum security code length, character types, and a sample security code, and receive an output of an acceptable level of error allowance via 1930 that can meet the requirements specified by the input. In this way, the administrator can design a security code system for the operating system with error allowance, while still providing a desired level of security. Note that GUI 1900 can interface with the security code selection tool and/or the security code validation engine, and can utilize a processor of the client device and/or remote server to provide these and other calculations.

A first non-limiting example scenario will be described for illustrating how some of the above approaches may be applied in practice. In this example scenario, a user may seek to access account information stored at least partially on a remote server via a computer (i.e. client device) communicatively coupled to the server by the Internet. A user upon seeking access to the account information may be prompted to create at least a password. The prompt may include instructions for creating the password including an indication of a minimum number of characters required for the password string. In this example, the user is prompted via the display of the computer to create a password having at least 8 characters. It should be appreciated that in this example, the user input may be performed via a QWERTY keyboard for the English language as described with reference to FIG. 5 and as described above, in some embodiments, the operating system of the client device and/or server may detect the type of keyboard used by the user for inputting the password.

Further, in this example, the characters that may be used for creating the username and password may be limited to include only alphabetic characters (e.g. A-Z) without case sensitivity and numbers (e.g. 0-9). Thus, the number of possible characters per character of the string in this example is 26+10=36 or the sum of the quantity of alphabetic characters (26) and the quantity of number characters (10) for a total of 36 possible characters. In this example, it will be assumed that the user creates a password having the minimum string length of 8 characters. Thus, the total number of combinations for the password of this example includes 36̂8=2,821,109,907,456 possible combinations or the number of possible characters for each character of the string (36) raised to the power of the string length (8).

Continuing with the first example scenario, after the username and password are created they may be stored and/or encrypted at the server and/or client computer for later validation. In this example, it will be assumed that the password created by the user is sent to the server where it is encrypted and stored in memory at the server. At a later time, the user may again seek to access the account information stored at the remote server via the computer. As such, the user may be prompted to submit the password previously created by the user. In this example, the user may input a string of characters for the password. However, in this example, due to a mistake by the user, the string inputted by the user contains an error. For example, the user may have accidentally selected the key representing the character “G” rather than the correct key representing the character “H” for the password having a correct string shown in FIG. 7A. As such, the user may be denied access to the account information stored on the server if no error allowance is applied. For example, the user may be notified of a password error and the user may seek to re-enter the password. If the user correctly enters the password during the second or subsequent attempt, then the user may be granted access to the account information stored on the server.

The above example illustrates how the user having to re-enter the password may use additional valuable time in order to re-enter the password to gain access. Further, if the user is disabled or physically impaired then correctly entering the password may be made more difficult. For example, a user having limited use of their hands may find it difficult to reliably enter their password or may not be able to enter it correctly after many attempts. This problem may be even further exacerbated if the operating system performs an operation where the account is frozen or locked for a period of time after a certain number of incorrect passwords are entered. These issues may deserve more consideration as the age of the technology using public begins to increase. For example, some public services such as Medicare, Medicaid, health insurance, prescription information, or disability assistance may be use a client device based access system via a password to enable the user to access their account information or to update information, etc.

Continuing with the first example scenario, instead of denying access to the user and requesting that they re-enter the password or lock access to the site, the operating system could instead utilize at least some level of error allowance. For example, the incorrectly entered password may have alternatively validated to allow access by recognizing that the “G” key is adjacent to the “H” key on the keyboard used by the user as shown in FIG. 5. However, granting access based on an incorrect password may also seem contrary to the concept of the password validation, since granting access to the user with an incorrect password may reduce the level of security. In particular, reduction in the level of security below the base level of security identified by the operating system may occur if the user created a password that included only the base string length.

As described above, the password requirements in this example were set so that there was 1 correct password out of a total 2,821,109,907,456 combinations or a probability of guessing the correct password of 1/2,821,109,907,456=3.5447E-13. If at least some level of error allowance is applied, such as allowing at least one error such as allowing the user to gain access via the use of the “G” key rather than the “H” key, then the level of security would have been reduced below the base level of security. For example, there would be 2 correct passwords out of a total 2,821,109,907,456 combinations or a probability of guessing a correct password of 2/2,821,109,907,456=7.08941E-13. In this regard, the lower probability may indicate a higher level of security and a higher probability may indicate a lower level of security. Thus, by including at least some error allowance, the level of security has been reduced. Further, if a greater error allowance is allowed, such as each key adjacent to the “H” key (e.g. as shown in FIG. 12) then there may be 7 correct passwords out of a total of 2,821,109,907,456 combinations or a probability of guessing a correct password of 7/2,821,109,907,456=2.48129E-12, thereby further reducing the level of security.

Further still, if only a single error were allowed for the entire password string based on a consideration of the adjacent keys to each key representing each character of the string, then the level of security would be reduced to approximately 56 correct passwords out of a total of 2,821,109,907,456 or a probability of 56/2,821,109,907,456=1.98503E-11. These examples have been provided to illustrate that the use of error allowance may reduce the level of security in some conditions.

However, if the base level of security was actually increased at password creation in anticipation of at least some level of error allowance being applied during later use of the password, then the use of error allowance may not necessarily reduce the level of security below the identified base level of security. For example, suppose that the actual base level of security included password string lengths of only 6 or more characters rather than 8 as indicated above. In other words, the user may have been notified of the requirement for a password string of 8 characters, which may have been greater than the base level of security enabling the use of error allowance without necessarily reducing the level of security below the base level.

For example, the base level of security may have instead been set to include a password string length of at least 6 characters or 36̂=2,176,782,336 combinations, or a probability of 1/2,176,782,336=4.59394E-10. If the applied error allowance included an allowance for a single error in a character of an 8 character string based on a key adjacent to the correct key, then the probability as described above would be equal or less than 1.98503E-11, which suggests that error allowance may be used such that the level of security higher is still higher than the base level of security of 4.59394E-10 identified for the six character string. In this manner, error allowance may be provided without necessarily reducing the level of security below a base level of security.

In practice, operating systems may apply error allowance to their present systems if a suitable error allowance is selected based on the operating conditions. For example, a first user that has already created a password having 10 characters on an operating system that had a minimum password length of 6 characters then a higher level of error allowance may be applied than if the user had instead created a password of 7 or 8 characters if we consider situations where the base level of security is not reduced.

Continuing with the first scenario, since the level of security provided above with the error allowance used with the 8 character string is greater than the base level of security, a greater error allowance may be user if desired. For example, the radius of key errors from the correct key may be increased to include other keys, for example as shown in FIG. 13. In this case, the probability would increase to include 11 possible allowed keys per correct key. In other words, the total number of correct passwords would increase to include 11*8=88 and the probability would then be equal to or less than 88/2,821,109,907,456=3.11934E-11, which provides a level of security higher than the base level of security identified by the six character password string having no error allowance and a probability of 4.59394E-10.

Thus has been described a first example scenario where error allowance may be applied without necessarily reducing the level of security below a base level of security. In this manner, a user may access password protected information or control features, where otherwise may have been difficult, more time consuming, or even impossible. Several other shorter examples of error allowance will be described that reference the errors identified above with reference to FIGS. 8A-8J.

As another example of an error allowance application, an error such as shown in FIG. 8G may be granted access if the error allowance considers a condition of multiple strokes of the same key. In particular, FIG. 8G shows how the error may include a repetition of the letter “B”. In some embodiments, the control system may detect the keyboard that was used to enter the password. If the keyboard included keys that may provide accidental multiple strokes if the key was depressed for too long (e.g. if the user had reduced reflexes), then the password may be allowed and access granted if two or more of the same character were included in the password string. However, in some embodiments, the operating system may not detect the keyboard used, but instead apply the multiple key stroke consideration based on the operating conditions such as the length of the correct password string in relation to the minimum length requirements or other suitable established security requirements.

Thus, it should be appreciated that any of the errors described above with reference to FIGS. 8A-8J or combinations thereof may be accepted if a suitable level of error allowance is applied. Further, errors of greater magnitude such as passwords having two, three, four, or more characters incorrect, out of order, missing, multiplied, etc. may still enable the user to access password protected information.

In some embodiments, an online business or other concern that utilizes a password based access approach may prompt a user to create a password that includes a higher level of security than is currently the minimum level of security. For example, a password string of 8 characters may be required of a user where only a password string of 4 or more characters is necessary. During some use of the password, a first level of error allowance may be provided to the user. However, at a later time, if a greater level of security is desired, the business may reduce the level of error allowance provided in order to increase the level of security without necessarily requiring the user to create a new password or modify their existing password.

While many of the examples provided herein describe increasing or decreasing the level of security by varying a string length of the password and/or username or the level of error allowance, it should be appreciated that security may be increased or decreased without necessarily requiring a change in the error allowance or string length. For example, the number of characters permitted per character of the string may be increased to increase security or vice versa. Further, features such as case sensitivity may also be employed to increase security, etc.

In some embodiments, the user may be provided an opportunity to change their password and/or username or the operating system may choose to change the password and/or username periodically without necessarily requiring user input. Where a password and/or username change has been performed by the user or by the operating system, the level of error allowance provided to the user may be varied in response to whether the user input is one of an old password and/or username that has been changed. For example, if a user has entered a previous password, then the error allowance may be adjusted to block access to the user even when the previous password would fall within the error allowance afforded to other similar password strings. In other words, suppose the old password was “P A S S W O R D 3” and the new password was “P A S S W O R D 4”, the control system may block access to the user if an input of “P A S S W O R D 3” is entered, but grant access if an input of “P A S S W O R D 5” is entered since the later input was not a previously associated password. Alternatively, an opposite approach may be applied. For example, an input including a previous password may be provided greater error allowance that a non-previous password input. In other words, with regard to the above example, the input of “P A S S W O R D 3” may be accepted while the input of “P A S S W O R D 5” may be rejected by the operating system.

FIG. 20 provides yet another example of how one of the base level of security, the error allowance, and the password or username string requirements may be determined based on the other two.

Note that the example control and estimation routines included herein can be used with various client device and network configurations. The specific routines described herein may represent one or more of any number of processing strategies such as event-driven, interrupt-driven, multi-tasking, multi-threading, and the like. As such, various steps, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated steps or functions may be repeatedly performed depending on the particular strategy being used. Further, the described steps may graphically represent code to be programmed into the computer readable storage medium in the client device and/or network server.

It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and non-obvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

The material set forth below provides additional examples of the subject matter that may be later introduced as claims, however, it should be appreciated that claims having different scope may also be introduced by Applicant at a later date.

A. A computer readable storage medium having stored data representing instructions executable by a computer, said storage medium comprising instructions for:

prompting a user to create a password;

receiving the password created by the user;

receiving a request for password protected information from the user;

prompting the user for the password in response to the request for password protected information;

receiving a first input from the user in response to said prompting the user for the password, wherein said first input does not include the password;

during a first condition of the password, providing the requested information to the user in response to the first input; and

during a second condition of the password, withholding the requested information from the user until a second input is received from the user, wherein said second input includes the password.

A.1 The storage medium of A, wherein the first condition of the password is where the password includes a first number of characters and the second condition of the password is where the password includes a second number of characters less than said first number of characters.

### A.2 The storage medium of A further comprising instructions for notifying the user that the first input is an incorrectly entered password at least during said second condition.

### A.3 The storage medium of A.2 further comprising instructions for prompting the user for the second input during the second condition.

### A.4 The storage medium of A.2 further comprising instructions for notifying the user that the first input is an incorrectly entered password during said first condition.

### A.5 The storage medium of A.4 further comprising instructions for notifying the user of a level of error allowance provided during at least the first condition.

B. A computer readable storage medium having stored data representing instructions executable by a computer, said storage medium comprising instructions for:

prompting a user to create a password;

receiving the password created by the user;

during a first condition, prompting the user to enter the password;

receiving a first input from the first user in response to said prompt during the first condition;

providing access to the first user when said first input is the same as the password;

during a second condition, prompting the user to enter the password;

receiving a second input from the user in response to said prompt during the second condition; and

providing access to the user when said second input is different than the password.

C. A computer readable storage medium having stored data representing instructions executable by a computer, said storage medium comprising instructions for:

prompting a user to create a password;

receiving the password created by the user;

storing a first value based on said password; and

storing at least a second value different from the first value based on a variation of the password.

### C.1 The storage medium of C, wherein said variation includes a variant password that may be accepted from the user in response to a subsequent prompt for the password to be entered.

D. A computer readable storage medium having stored data representing instructions executable by a computer, said storage medium comprising:

instructions for:

assigning a first password to a first user;

receiving a first input from the first user;

providing access to the first user when said first input includes a first difference from the first password.

D.1 The storage medium of D further comprising, instruction for:

assigning a second password to a second user;

receiving a second input from the second user; and

denying access to the second user when said second input includes a second difference from the second password.

### D.2 The storage medium of D.1, wherein said first input includes a greater number of characters than said second input.

### D.3 The storage medium of D.1, wherein said first difference is less than said second difference.

### D.4 The storage medium of D.1, wherein said first input includes a greater string length than said second input.

### D.5 The storage medium of D.1, wherein said first password includes a greater level of security than said second password.

### D.6 The storage medium of D.1, wherein said first password includes a greater number of characters than said second password

D.7 The storage medium of D further comprising, instruction for:

assigning a third password to a third user;

receiving a third input from the third user; and

providing access to the third user when said third input is the same as the third password.

### D.8 The storage medium of D, wherein said first difference includes a difference of one character between the first password and the first input.

### D.9 The storage medium of D.8, wherein the different character of the first password is located adjacent to the different character of the first input on a keyboard operated by the first user to enter the first input.

### D.10 The storage medium of D.1, wherein said second difference includes a difference of at least two characters between the second password and the second input.

### D.11 The storage medium of D further comprising, instructions for detecting a keyboard used by the first user to enter the first input.

### D.12 The storage medium of D, wherein said first difference includes at least one different character.

### D.13 The storage medium of D, wherein said first difference includes said first input having at least one additional character than said first password.

### D.14 The storage medium of D.13, wherein said at least one additional character includes at least one character similar to another character of the first input.

### D.15 The storage medium of D, wherein said first difference includes said first input having at least one less character than said first password.

E. A computer readable storage medium having stored data representing instructions executable by a computer, said storage medium comprising: instructions for:

receiving a first password created by a first user, wherein said first password is for providing the first user with access to a first quanta of information;

receiving a first input from the first user, wherein said first input is the same as said first password;

providing the first quanta of information to the first user in response to the first input;

receiving a second password created by a second user, wherein said second password is for providing the second user with access to a second quanta of information;

receiving a second input from the second user, wherein said second input is different than said second password;

providing the second quanta of information to the second user in response to the second input.

F. An information retrieval system, comprising:

a display device for displaying information;

an input device for receiving an input from a user;

a control system for transmitting information to the display device and receiving information from the input device;

said control system configured to:

store a password created by the user;

during a first operation, receive a first input from the user;

transmit password protected information to the display device for display in response to the first input, wherein said first input is the same as said password;

during a second subsequent operation, receive a second input from the user;

transmit the password protected information to the display device for display in response to the second input, wherein said second input is different from said password.

G. Instructions for creating a password for accessing an online user account, the instructions comprising:

a first password requirement including a first minimum number of characters for creating the password and enabling the user to access the user account in response to a subsequent entry of the password including no errors; and

a second password requirement including a second minimum number of characters greater than said first minimum number of characters for creating the password and enabling the user to access the user account in response to a subsequent entry of the password including an error.

### G.1 The instructions of G, wherein said instructions are displayed via a display device of a computer.

H. A method of accessing an email account via a computer, the method comprising:

creating a password including a first group of characters;

submitting said password including the first group of characters via a keyboard of the computer;

entering a second group of characters via the keyboard of the computer in response to a prompt for said password;

accessing the email account based on said entered second group of characters, wherein said second group of characters does not include said first group of characters.

I. A method of accessing an email account via a computer, the method comprising:

creating a password including a first group of characters;

submitting said password including the first group of characters via a keyboard of the computer;

entering a second group of characters via the keyboard of the computer in response to a prompt for said password;

accessing the email account based on said entered second group of characters, wherein said second group of characters is different from said first group of characters.

J. A method of marketing an internet business, the method comprising:

advertising an internet business, said advertisement including a notification that said internet business provides access to a user when a password submitted to a website of the internet business includes at least one error;

operating said website by receiving an input submitted by a user via the website and granting access to the user in response to said input including a password containing at least one error.

K. A method of operating a computer, the method comprising:

creating a password for accessing a user account;

submitting the password to gain access to the user account in response to a first request for the password;

accessing the user account based on the submitted password;

submitting a variant of the password to gain access to the user account in response to a second request for the password;

accessing the user account based on the submitted variant of the password.

L. A computer readable storage medium having stored data representing instructions executable by a computer, said storage medium comprising instructions for:

assigning a password to a user account;

providing access to the user account a first time based on a comparison of a first input and the password;

providing access to the user account a second time based on a comparison of a second input and the password, where said second input is different from said first input.

M. A computer readable storage medium having stored data representing instructions executable by a computer, said storage medium comprising instructions for:

prompting a user to create a password;

receiving the password;

assigning the password to a user account;

providing access to the user account a first time based on a comparison of a first input and the password;

providing access to the user account a second time based on a comparison of a second input and the password, where said second input is different from said first input.

N. A computer readable storage medium having stored data representing instructions executable by a computer, said storage medium comprising instructions for:

prompting a user to create a password;

receiving the password;

storing a value in memory based on the received password;

providing access to the user account a first time based on a comparison of a first input and the stored value;

providing access to the user account a second time based on a comparison of a second input and the stored value, where said second input is different from said first input.

O. A computer readable storage medium having stored data representing instructions executable by a computer, said storage medium comprising instructions for:

dividing a keyboard communicatively coupled to the computer into at least a first region and a second region, said first region including at least a first key and a second key and said second region including at least a third key;

receiving a first input from the first key and assigning said first input as a first value;

receiving a second input from the second key and assigning said second input as said first value;

receiving a third input from the third key and assigning said third input as a second value different from the first value.

P. A computer readable storage medium having stored data representing instructions executable by a computer, said storage medium comprising instructions for:

granting access to a user based on an incorrectly entered password in response to a first level of security; and

denying access to a user based on the incorrectly entered password in response to a second level of security;

wherein the incorrectly entered password is different than a correct password that was created by the user.

Q. A computer readable storage medium having stored data representing instructions executable by a computer, said storage medium comprising:

instructions for:

receiving an input from a user via a keyboard;

detecting a condition of the keyboard;

varying a level of access provided to the user in response to the detected condition of the keyboard.

R. A computer readable storage medium having stored data representing instructions executable by a computer, said storage medium comprising:

instructions for:

receiving an input from a user via a keyboard;

detecting a condition of the keyboard;

varying a level of access provided to the user in response to the input and the detected condition of the keyboard.

### R.1 The storage medium of R, wherein the condition of the keyboard includes a key configuration of the keyboard.

### R.2 The storage medium of R, wherein the condition of the keyboard includes a number of keys of the keyboard.

### R.3 The storage medium of R, wherein the condition of the keyboard includes a size of the keyboard.

S. A computer readable storage medium having stored data representing instructions executable by a computer, said storage medium comprising:

instructions for:

receiving an input from a user via a keyboard;

detecting a condition of the keyboard;

correcting the input based on the detected condition of the keyboard.

### S.1 The storage medium of S, wherein the condition of the keyboard includes a key configuration of the keyboard.

### S.2 The storage medium of S, wherein the condition of the keyboard includes a number of keys of the keyboard.

### S.3 The storage medium of S, wherein the condition of the keyboard includes a size of the keyboard.

T. A method of providing financial information to a user, the method comprising:

receiving a request from a user for financial information;

prompting a user for a password in response to the request for financial information;

during a first mode:

receiving a first input from the user in response to the prompt for the password;

providing the requested financial information to the user in response to the first input, wherein the first input does not include the password.

T.1 The method of T, further comprising during a second mode:

receiving a second input from the user in response to the prompt for the password;

denying access to the requested financial information to the user in response to the second input, wherein the second input is different from the password.

### T.2 The method of T.1, further comprising prompting the user to select between one of the first mode and the second mode.

U. A method of providing a user with access to secure information via a client device, the method comprising:

receiving a password string from the user, wherein the string includes an error;

providing access to the user when said error is less than an error allowance; and

denying access to the user when said error is greater than the error allowance.

U.1 The method of U, wherein said error allowance is varied in response to a condition of at least one of the user, the client device, an input device that the user used to input the password; a condition of another user, a base level of security, a condition of the password string, a condition of the correct password, a condition of information learned from past user interaction with the client device, and a mode selected by the user.
U.2 The method of U, wherein the error allowance is selected by at least one of the user or a system administrator.

1. A method of managing user access via a client device, the method comprising:
assigning a password to the user;
prompting the user to input the password via an input device of the client device;
receiving an input from the user via the input device responsive to said prompting;
granting access to the user when the received input is the same as the password;
granting access to the user when the received input is not the same as the password and includes a first incorrect character; and
denying access to the user when the received input is not the same as the password and includes at least a second incorrect character different from the first incorrect character.

2. The method of claim 1, wherein a first key of the input device for inputting the first incorrect character is located more proximate to a second key of the input device for inputting a corresponding correct character of the password than a third key of the input device for inputting the second incorrect character.

3. The method of claim 1, wherein the input including the second incorrect character further includes a greater number of incorrect characters than the input including the first incorrect character.

4. The method of claim 1, wherein the input including the second incorrect character includes a different quantity of characters than each of the password and the input including the first incorrect character.

5. The method of claim 4, wherein the input including the first incorrect character includes a first quantity of characters and the input including the second incorrect character includes a second quantity of characters; and wherein the second quantity of characters is greater than or less than the first quantity of characters.

6. The method of claim 1, wherein the password assigned to the user was selected by the user and wherein the client device is communicatively coupled with a wide area network.

7. The method of claim 1, wherein said prompting includes displaying a password field via a display device of the client device and wherein the received input is provided to the password field.

8. A network system, comprising:
a network server;
a client device communicating with the network server via a network;
a password selection tool configured to enable the user to select a password that includes at least a minimum number of characters; and
a password validation engine configured to prompt the user for the password responsive to a request by the user for information stored at the server, wherein the password validation engine is configured to receive a user response to said prompt via the client device;
wherein the password validation engine is further configured to compare the password selected by the user with the user response to identify correct password characters contained in the user response, and responsive to said comparison:
grant the user access to the information stored on the server when the user response includes less than all of the correct password characters and at least a first number of correct password characters; and
deny the user access to the information stored on the server when the user response includes less than all of the correct password characters and a second number of correct password characters less than the first number of correct characters.

9. The system of claim 8, wherein the password validation engine is further configured to grant the user access to the information stored on the server when the user response includes a first number of correct password characters that is less than all of the correct password characters and at least the same as or greater than the minimum number of password characters; and deny the user access to the information stored on the server when the user response includes a second number of password characters less than all of the correct password characters and less than the minimum number of characters.

10. The system of claim 8 further comprising, a network administrator interface configured to enable a network administrator to select the minimum number of characters for the password selected by the user.

11. The system of claim 8, wherein the client device includes an input device; and
wherein the password is selected by the user via the input device and the user response is provided to the password validation engine via the input device.

12. The system of claim 8, wherein the password selection tool and the password validation engine reside at the server and are accessed by the user via the client device.

13. The system of claim 8, wherein the network includes a wide area network.

14. The system of claim 13, wherein the wide area network includes the Internet.

15. A method of managing access of a user of a network client, the method comprising:
assigning a security code to the user;
receiving an access request from the user via an input device of the network client, wherein the access request is received at a server communicating with the network client via a network;
requesting a security code from the user via a graphical user interface of the network client in response to the received access request;
receiving a response from the user via the input device of the network client responsive to the security code request, wherein the response is received at the server;
generating a plurality of security code variations at the server based on the security code assigned to the user;
granting the requested access to the user when the response received at the server includes the security code or one of the generated security code variations; and
denying the requested access to the user when the response received at the server does not include the security code or one of the security code variations.

16. The method of claim 15, wherein the number of security code variations that are generated at the server is selectable by a network administrator.

17. The method of claim 15, wherein the security code includes a password.

18. The method of claim 15, wherein the security code includes a username.

19. The method of claim 15, wherein the access request by the user includes a request for secure information to be provided to the user of the network client.

20. The method of claim 15, wherein the access request by the user includes a request for additional control to be provided to the user of the network client.
